(19) United States
(12) Patent Application Publication
(10) Pub. No.: US 2019/0358779 A1
(43) Pub. Date: Nov. 28, 2019

(54) Two-in-One Angle Clamp

(71) Applicant: Harry WONG, South Pasadena, CA (US)

(72) Inventor: Harry WONG, South Pasadena, CA (US)

(21) Appl. No.: 15/987,625

(22) Filed: May 23, 2018

(51) Int. Cl. B25B 5/00; B25B 1/10; B25B 1/22

(52) U.S. Cl. CPC B25B 5/003; B25B 1/22; B25B 1/103

(57) ABSTRACT

Present invention teaches a two-in-one angle clamp where individual angle clamps can be moved and locked to a desired angle on a base plate to work with work pieces set at an desired angle to each other, with supporting magnet rest pieces to provide horizontal support at a height that's either matching the thickness of the base plate or the combined thickness of the base plate and the clamping head.

### FIELD AND BACKGROUND OF THE INVENTION

Present invention disclosed a two-in-one angle clamp where individual angle clamps, used together or individually, can be moved and locked to a desired angle on a base plate where an angular degree reading is shown around a perpendicular shaft.

Work pieces can be set at any desired angle relative to each other, due to a locking screw provided to the angle clamp. Supporting magnet rest pieces provide horizontal support at a height that's either matching the thickness of the base plate or the combined thickness of the base plate and the clamping head.

### SUMMARY OF THE INVENTION

The invention relates to a two-in-one angle clamp primarily consists of a metal base plate and two angle clamps.

The metal base plate has two out-extending arms; each arm has a perpendicular shaft located near a distal end of said arm. A circular marking is made around the shaft, providing visible angular readings.

Each angle clamp has a through hole sized to snugly fit around the perpendicular shaft to allow rotating the angle clamp around the shaft. Said at least one angle clamp has a locking screw for locking the angle clamp in any desired angle relative to the base plate. The circular marking around each shaft provides a user with the clue as to the desired angle.

The two-in-one angle clamp of present invention has at least one magnet rest piece to provide horizontal support when work piece(s) is/are being secured by the angle clamp. The at least one magnet rest piece is made to be substantially in a rectangular shape, with the length to be twice as long as the width, and with the width set to equate the thickness of the base plate, so as to provide a horizontal support for work pieces when placed on the clamping head of the at least one angle clamp.

The at least one magnet rest piece is made of magnetizable material with at least one permanent magnet inside. The width of the at least one magnet rest piece is made to be the same thickness of the base plate. In a specific embodiment, the at least one magnet rest piece has a width of one inch (matching the thickness of the base plate) and a length of two inches (matching the combined thickness of the base plate and the clamping head).

### DESCRIPTION OF THE DRAWINGS

The accompanying drawings, which are incorporated in and constitute a part of this specification, illustrate and exemplify the preferred embodiments of the invention. Together with the description, serve to explain the principles of the invention.

A brief description of the drawings is as follows:

FIG. 1 is the perspective view of the present invention.

FIG. 2 is the perspective view of the base plate of the present invention.

FIG. 3 is the perspective view of one of the angle clamps showing the top portion.

FIG. 4 is the perspective view of one of the angle clamps showing the bottom portion and the locking screw.

FIG. 5 shows the present invention clamping two rectangular tubes oriented at an angle to each other.

FIG. 6 is the perspective view of the magnet rest piece.

FIG. 7 shows the present invention clamping two long rectangular tubes connected at an angle to each other and supported by two magnetic rest pieces (used vertically).

FIG. 8 shows one of the angle clamps clamping one long rectangular tube supported by a magnetic rest piece (used horizontally).

### DETAILED DESCRIPTION OF THE PREFERRED EMBODIMENT

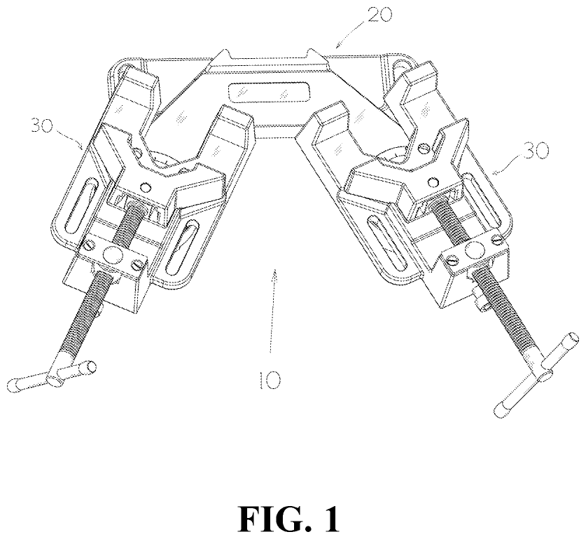

The two-in-one angle clamp 10 of present application primarily consists of a metal base plate 20 and two angle clamps 30, as shown in FIG. 1.

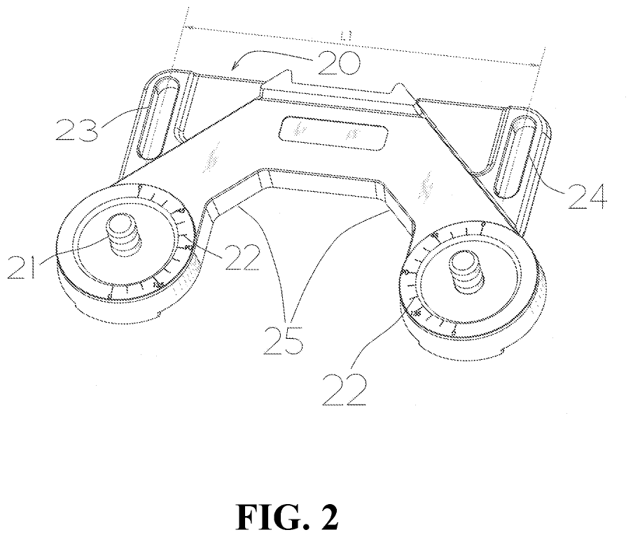

As shown in FIG. 2, the two-in-one angle clamp has a metal base plate 20, having at least two arms 25 branching outwardly. Mounting slots 23 and 24 are made respectively on each arm 25. The mounting slots 23/24 are used to mount the base plate 20 to the surface of a welding table with corresponding mounting screws.

As shown, the axial lines of mounting slots 23 and 24 are parallel to each other, with a distance of L1 measured between the center axial lines. L1 can be made to be multiple of 2 inches (or 50 cm in metric version) which is the distance between center lines of two adjacent mounting holes of a common commercial grade welding table. This feature allows mounting the present invention anywhere on the surface of a welding table.

Each arm has a perpendicular shaft 21 located near a distal end of said arm 25. A circular marking 22 is made around the shaft 21, providing visible angular readings.

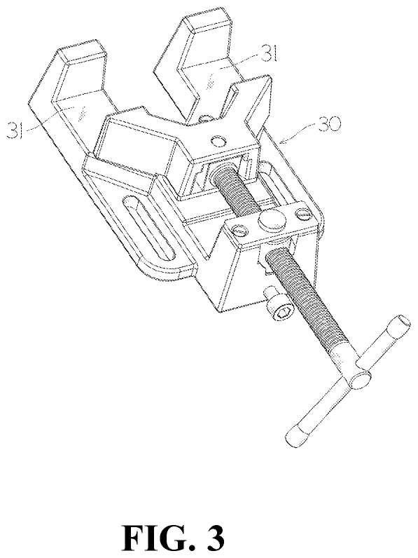

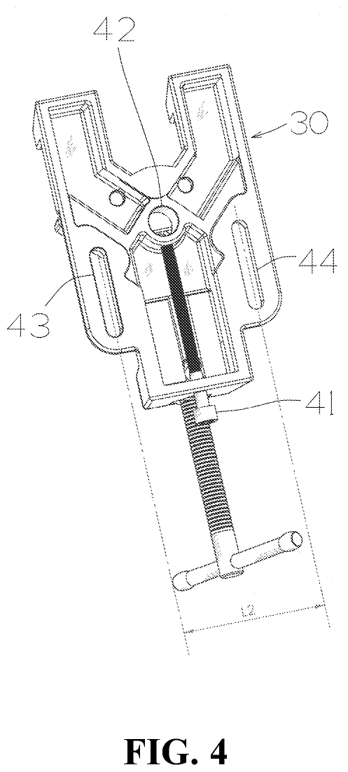

As shown in FIGS. 3 & 4, at least one angle clamp 30 with a through hole 42 is provided. Said through hole 42 is sized to snugly fit around the perpendicular shaft 21 to allow rotating the angle clamp around the shaft 21.

Said at least one angle clamp further has two ear slots 43 and 44 symmetrically located on the two side of said locking screw 41. The two ear slots 43 and 44 are used to mount said at least one angle clamp to the surface of a welding table with corresponding mounting screws. The axial lines of the ear slots 43 and 44 are parallel to each other, with a distance of L2 measured between the center axial lines. L2 can be made to be multiple of 2 inches (or 50 cm in metric version) which is the distance between center lines of two adjacent mounting holes of a common commercial grade welding table. This feature allows mounting the present invention anywhere on the surface of a welding table.

Said at least one angle clamp 30 has a clamping head 31 area where work objects will be placed, and secured by the clamping function. Said at least one angle clamp 30 has a locking screw 41 for locking the angle clamp 30 in any desired angle relative to the base plate 20. The circular marking 22 around shaft 21 provides a user with the visual clue as to the desired angle, any angle within the normal 360-degree range, relative to the base plate for locking the angle clamp 30.

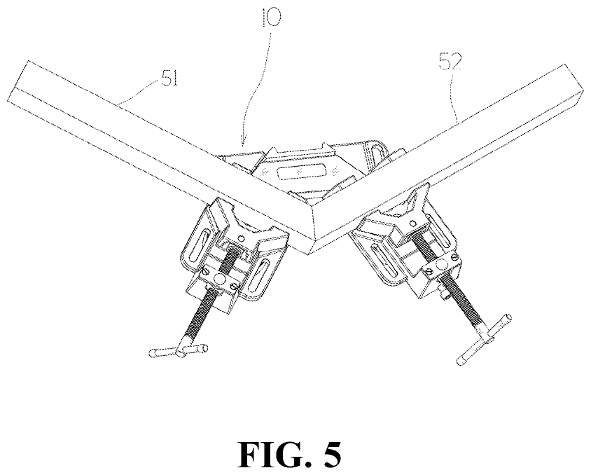

With this arrangement, two work pieces 51 and 52, which may be tubes, bars, or other objects, may be clamped at any angle relationship between each other, as shown in FIG. 5.

The base plate's 20 thickness is made to be the same as the clamping head's 31 thickness. In a specific embodiment, the base plate 20 thickness is one inch, as is that of the clamping head 31.

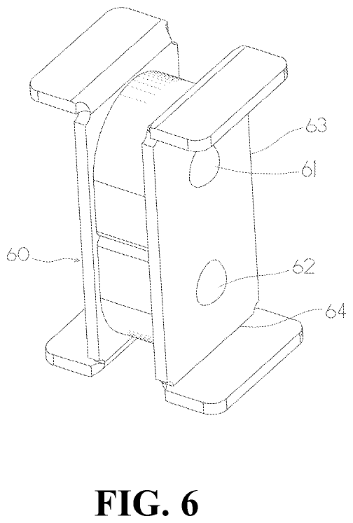

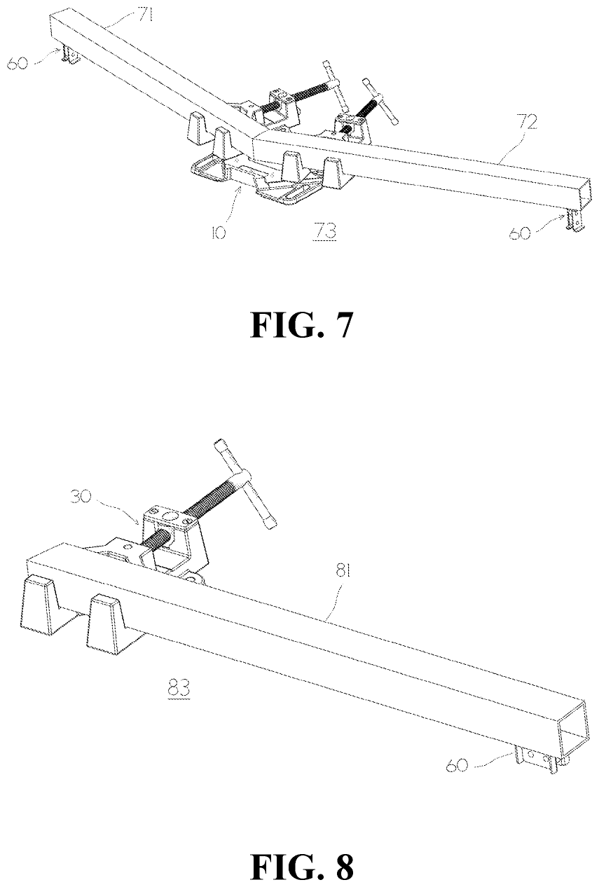

As shown in FIGS. 6, 7 & 8, the two-in-one angle clamp of present invention has at least one magnet rest piece 60 to provide horizontal support when work piece(s) is/are being secured by the angle clamp 30. The at least one magnet rest piece 60 is made to be substantially in a rectangular shape, with the length to be twice as long as the width, and with the width set to equate the thickness of the base plate 20, so as to provide a horizontal support for work pieces when placed on the clamping head 31 of the at least one angle clamp 30.

The at least one magnet rest piece 60 is made of magnetizable material with at least one permanent magnet 61 inside. The at least one magnet rest piece 60 may further contain side pieces 63 and 64 that are made of magnetizable material, so as to provide bigger contact surface with work pieces. Additional permanent magnet 62 may be used inside the magnet rest piece 60, where magnets 61 and 62 are of different magnetic powers, for easy removal of the magnet rest piece 60.

The width of the at least one magnet rest piece 60 is made to be the same thickness of the base plate 20. In a specific embodiment, the at least one magnet rest piece has a width of one inch (matching the thickness of the base plate 20) and a length of two inches (matching the combined thickness of the base plate 20 and the clamping head 31).

When the angle clamp 30 is used individually to clamp a straight work piece 81, see FIG. 8, the bottom surface of the work piece 81 will be one inch above the surface of the work table. If the angle clamp(s) 30 are used with the base plate 20 to clamp work pieces 71 and 72, as shown in FIG. 7, the bottom surfaces of the work pieces 71/72 will be two inches above the surface of the work table. The use of the rectangular magnetic rest piece(s) 60 can be set by its appropriate width-side or length-side, to provide the horizontal levelness needed.

1. A two-in-one angle clamp, comprising,
a metal base plate;
at least two arms branching outwardly, each arm further having a mounting slot and a perpendicular shaft located near a distal end of the arm;
a circular marking is made around the shaft, providing visible angular readings; and
at least one angle clamp with a through hole sized to snugly fit around the perpendicular shaft to allow rotating said at least one angle clamp around the shaft, said at least one angle clamp further having a locking screw for locking the angle clamp in any desired angle relative to the base plate, said at least one angle clamp further having two ear slots symmetrically located on the two sides of said locking screw.

2. The angle clamp of claim 1 wherein the thickness of clamping head is made to be the same as the thickness of the base plate.

3. The angle clamp of claim 2 wherein at least one magnet rest piece is made to be substantially in a rectangular shape with the length to be twice as long as the width, with the width set to equate the thickness of the base plate, so as to provide a horizontal support for work pieces when placed on the clamp head of the angle clamp.

4. The angle clamp of claim 3 wherein the magnet rest piece has at least one permanent magnet embedded inside.

5. The angle clamp of claim 3 wherein the magnet rest piece has one permanent magnet with stronger magnetic power and one permanent magnet with weaker magnetic power for easy removal of the magnet rest piece.

6. The angle clamp of claim 3 wherein the magnet rest piece may further contain side pieces made of magnetizable material with more than one permanent magnets embedded inside.

7. The angle clamp of claim 4 wherein the thickness of the base plate is one inch and the thickness of the clamping head is also one inch, and wherein the at least one magnet rest piece has width of one inch and length of two inches.

8. The angle clamp of claim 1 wherein the axial lines of the mounting slots are parallel to each other, the distance between the axial lines are made to be multiple of 2 inches (or 50 cm in metric version) and wherein the axial lines of the ear slots are parallel to each other, the distance between the axial lines are made to be multiple of 2 inches (or 50 cm in metric version).
